(19) United States
(12) Patent Application Publication
(10) Pub. No.: US 2002/0046248 A1
(43) Pub. Date: Apr. 18, 2002

(54) Email to database import utility

(75) Inventor: Jerome P. Drexler, Wyoming, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 09/974,222

(22) Filed: Oct. 9, 2001

Related U.S. Application Data
(60) Provisional application No. 60/240,594, filed on Oct. 13, 2000.

(51) Int. Cl. G06F 15/16; G06F 7/00; G06F 17/30

(52) U.S. Cl. 709/206; 707/10

(57) ABSTRACT

The present invention facilitates the transfer of data from an email message or the like to records, tables, and/or fields of an electronic database. In an illustrative embodiment, an email message and a number of database fields are identified. Certain data from the email message are associated with one or more of records, tables, and/or fields of the database. With this association, the data in the email message may be automatically or manually parsed and saved to the associated records, tables, and/or fields of the database.

This application claims priority under 35 U.S.C.§119(e)(1) to co-pending U.S. Provisional Patent Application Ser. No. 60/240,594, filed Oct. 13, 2000, and entitled “Email to Database Import Utility”.

### FIELD OF THE INVENTION

This invention generally relates to methods and systems for importing data to a database and more specifically, to methods and systems for importing data to a database from an electronic mail (email) message or the like.

### BACKGROUND OF THE INVENTION

In recent years, more and more individuals and companies have made the Internet a tool of business. Because the Internet enables rapid and widespread distribution of data, it is becoming a popular means for communication. Email has been one popular conduit for this increased communication. In order to capitalize on this trend, many businesses and individuals have begun using electronic mail to send more and different types of information, moving beyond personal messages. Email is now commonly used to send larger quantities and/or different types of information quickly and securely. The general character of email is commonly known in the art.

Many businesses and individuals have also continued to use various types of databases to manage information. Many such databases include a number of different records, tables, and/or fields. A field within a database can operate as a category of information. For example, a database could have one field for quantity and another field for price. If five products are sold for ten cents each, the transaction may be recorded by storing a value of five in the quantity field and ten cents in the price field. The general characteristics of electronic databases are well known in the art.

### SUMMARY OF THE INVENTION

The present invention facilitates the transfer of data from an email message or the like to locations such as records, tables, and/or fields of a database. In an illustrative embodiment of the present invention, an email message and a database are identified. Certain data or locations of data in the email message (message text and/or email attachment) are then associated with one or more locations (such as records, tables, and/or fields) in the database. Once the association is established, data from subsequent email messages that have a similar format may be automatically parsed and saved to the associated locations in the database.

In accordance with one illustrative embodiment of the present invention, data is recorded to the database by receiving an email message, selecting a first subset of data within the email message, and saving the first subset of data to a first record, table and/or field in a database. Then, a second subset of data is selected, and saved to a second record, table and/or field in the database, as desired. This may be repeated until all of the desired subsets of data from an email message are saved to the appropriate record, table and/or field in the database. Rather than saving the subsets of data sequentially, it is contemplated that the various subsets of data may be saved to temporary locations, and subsequently saved to the appropriate records, tables and/or fields in the database. In some cases, various subsets of data from a single email message may be save to two or more databases, if desired.

The selection and association of data in an email message may be manually or automatically performed. In one illustrative embodiment, the present invention uses data selection criteria to create parsed data strings from an email message of a particular known format. In one embodiment, the email message is parsed by searching the text of the message for a predefined delimiting character. The email message may then be divided into parsed data strings using the position(s) of the delimiting characters. In other embodiments, an email message may be initially parsed by a user, with the position of each parsed data string identified by the user. The phrase “email message” as used herein may include the email message itself as well as any accompanying email attachments, depending on the application.

Once parsed, selected data strings are preferably associated with selected records, tables and/or fields of one or more databases. In some embodiments, the association is initially specified by a user. Alternatively, the association may be hardwired or hardcoded, as desired. After the association is designated, information relating to the association is preferably saved into an association record or the like. Using the information of the association, the parsed data strings from an incoming email message may be automatically associated and saved to an appropriate records, tables and/or fields of a database.

### BRIEF DESCRIPTION OF THE DRAWINGS

FIG. 1 is a block diagram showing a conceptual data flow of an illustrative embodiment of the present invention;

FIG. 2 is a block diagram showing an operations tree for an illustrative embodiment of the present invention;

FIG. 3 is a block diagram showing an illustrative process in accordance with an illustrative embodiment of the present invention;

FIG. 4 is a screen shot of an illustrative graphical user interface for designating an association;

FIG. 5 is a screen shot of an illustrative graphical user interface for manually associating data within an email message with fields within a database;

FIG. 6 is a screen shot of an illustrative graphical user interface for manually associating data within an email attachment with fields within a database;

FIG. 7 is a screen shot of an illustrative graphical user interface for mapping parsed data strings from an email message to database table fields;

FIG. 8 is a table showing the operation of an illustrative embodiment of the present invention;

FIG. 9 is a table showing the operation of another illustrative embodiment of the present invention;

FIG. 10 is a table showing the operation of yet another illustrative embodiment of the present invention;

FIG. 11 is a table showing the operation of still another illustrative embodiment of the present invention; and

FIG. 12 is a table showing the operation of another illustrative embodiment of the present invention.

### DETAILED DESCRIPTION OF THE DRAWINGS

The detailed description that follows is presented largely in terms of algorithms and symbolic representations of operations performed using a data processing system. These algorithmic descriptions and representations are the means used by those skilled in the data processing arts to most effectively convey the substance of their work to others skilled in the art.

An algorithm is here, generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, strings, values, elements, symbols, characters, terms, numbers or the like. It should be kept in mind, however, that all of these and similar terms are to be associated with the appropriate physical quantities and are merely convenient labels applied to these quantities.

The present invention also relates to an apparatus for performing the operations. This apparatus may be specially constructed for the required purposes or may be a general-purpose computer as selectively activated or reconfigured by a computer program. The algorithms presented herein are not inherently related to a particular computer system or other apparatus. In particular, various general purpose computer systems may be used with computer programs written in accordance with the teachings of the present invention, or it may prove more convenient to construct more specialized apparatus, to perform the required method steps. The required structure for such machines will be apparent from the description given below.

In sum, the present invention preferably is implemented for practice by a computer, e.g., a source code expression is input to the computer to control operations therein. It is contemplated that a number of source code expressions, in one of many computer languages, could be utilized to implement several aspects of the present invention. A variety of computer systems can be used to practice the present invention, including, for example, a personal computer, an engineering work station, a hardware simulator, an enterprise server, etc. The present invention, however, is not limited to practice on any one particular computer system, and the selection of a particular computer system can be made for many reasons.

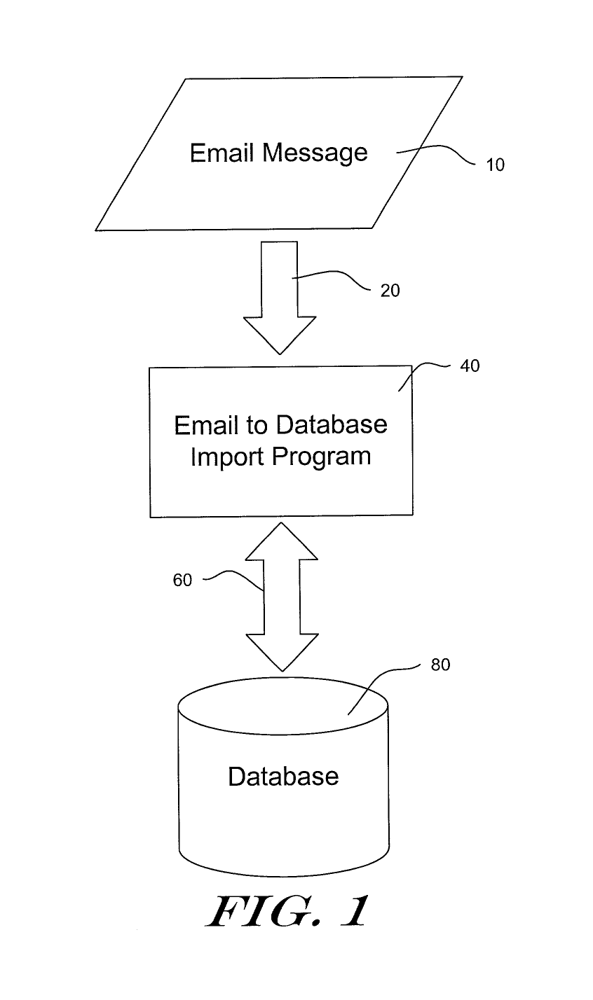

FIG. 1 is a block diagram showing a conceptual data flow of an illustrative embodiment of the present invention. An email message 10 is provided to an email to database import utility program 40. The utility program 40 has access to an association 60 and a database 80. The email message 10 may be of various types and formats. A typical email message 10 may include information such as the address of the sender, the address of the recipient, and message text. Such an email message 10 could also include an attachment, such as a file or program, or header lines such as a subject line, a CC line, a BCC line, etc. Email utilities for writing, addressing and sending email messages 10 are commercially and widely available. Some example email utilities include Netscape Messenger®, Microsoft Outlook® and Novell GroupWise®, though there are many other such programs with wide variations in look, approach, graphics and utilities.

It is contemplated that the present invention may be used with an email message 10 generated from any email program, including programs that may be developed for or by individual users and that are not commercially available. It is also contemplated that the present invention may be used in conjunction with a second software application with a graphical user interface to receive information from a user, incorporate the information into an email message of a known format, and send the email message to a predetermined address. It is further contemplated that the present invention may not require that an email message be received via the Internet, and may be used in conjunction with other communications services including intranets, local area networks, wide area networks, private distributed networks, or other media for transmitting data between local, distributed, or remote locations.

Database 80 may be a commercially available or privately created program. Commercially available database programs include, for example, Microsoft SQL Server 2000®, Oracle 9i®, Microsoft Excel™, Microsoft Access™, Lotus Access , Appleworks 6.2™, etc. The database 80 preferably includes a number of records, tables and/or fields to which data may be recorded.

The email to database import utility program 40 preferably receives the email message 10 as shown at 20. The utility program 40 uses the association 60 to associate and save certain data from the email message 10 to appropriate records, tables or fields in the database 80. The utility program 40 preferably determines whether data from the email message 10 should be saved to the database 80, and the association 60 identifies which data from the email message 10 is to be saved, and which fields the data is to be saved in the database 80. These determinations by the utility program 40 and/or the association 60 are further explained below.

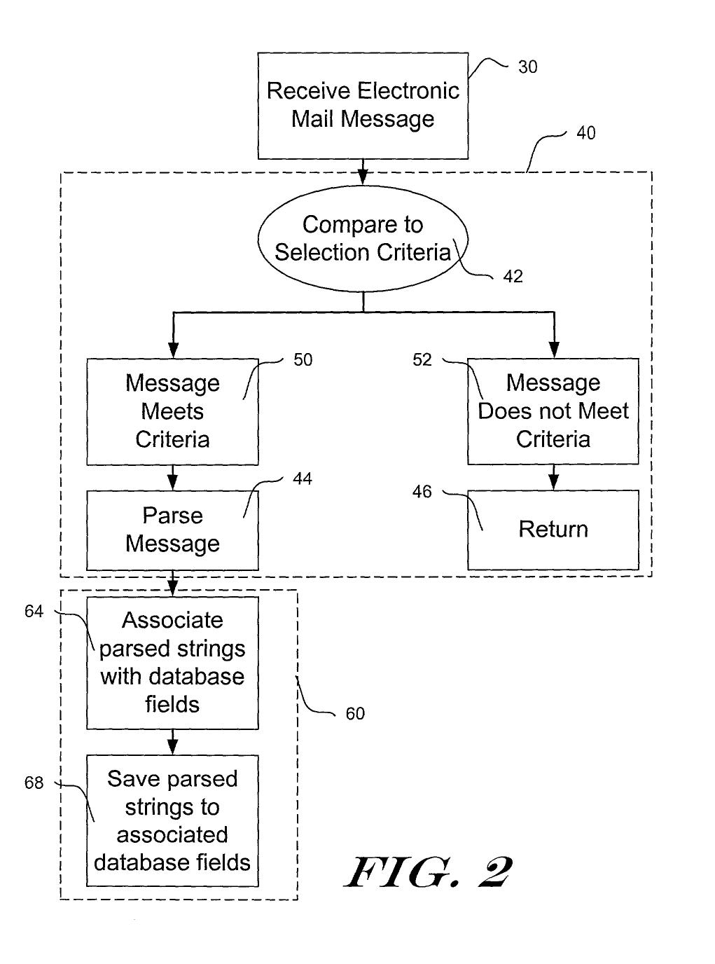

FIG. 2 is a block diagram showing an operations tree for an illustrative embodiment of the present invention. The operations tree shows receipt of an email message at 30. The received email message is provided to utility program 40. The illustrative utility program 40 has three primary blocks including a comparison block 42, a parsing block 44, and a return block 46. The comparison block 42 compares the email message to a number of predefined selection criteria. The predefined selection criteria preferably help identify those email messages that are in a particular format. If the email message meets the predefined selection criteria 50, control is passed to the parse message block 44. The parse message block parses the message into a number of data strings. If the email message fails to meet the predefined selection criteria, as shown at 52, control is passed to the return block 46.

There are numerous methods that may be used to parse the email message. In one illustrative embodiment, the parsing block 44 identifies the locations of a designated delimiter character in the email message. Parsed data strings may include, for example, consecutive data elements or characters preceding the first appearance of the delimiter character, consecutive data elements or characters appearing between successive appearances of the delimiter character, and/or consecutive data elements or characters following the last appearance of the delimiter character. Also, a parsed data string may be a predefined number of characters preceding or following each appearance of the delimiter character. Many other parsed data string definitions may be used, depending on the application at hand and the format of the received email message 30.

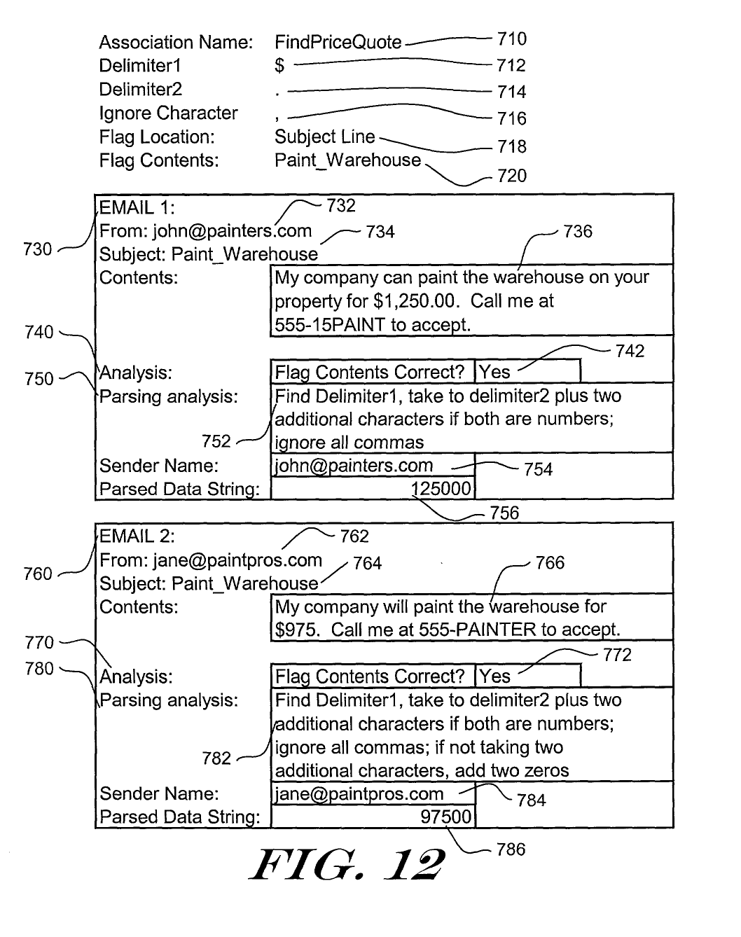

In some embodiments, the parse message block 44 may ignore certain character information. Some email messages may have characters that other programs may not understand, as for example when a received email message incorporates an image or picture and the program reading the received message does not enable the image to be viewed. To accommodate these situations, it is contemplated that the parse message block 44 may ignore certain characters, such as non-ASCII characters. FIG. 12 includes an illustrative example of such a parsing technique. It is also contemplated that multiple delimiting characters may be used in the same applications. Also, rather than using a character for a delimiter, a word, phrase, or other series of symbols can be used as a delimiter, including symbols or characters not ordinarily displayed on the screen, if desired.

It is contemplated that the return block 46 may initiate more than a simple stop command. The return block 46 may, for example, initiate other functions such as configuring the utility program 40 to receive another message 30, move the current message 30 to another folder such as an inbox, etc. Alternatively, or in addition, the return block 46 may return control to the compare to selection criteria block 42, which can then compare the current message 30 to another set of selection criteria, if desired. This may be particularly useful when utility program 40 is configured to receive and process email messages that have more then one message format. When so provided, the utility program 40 may compare each message against several different sets of criteria, and parse the messages accordingly.

After the message (and/or attachment) is parsed by the parse message block 44, control may be passed to association block 60. Association block 60 includes a string association block 64 and a save block 68. The string association block 64 associates parsed data strings with corresponding database fields 64. The association may be implemented in any number of ways including, for example, selecting a parsed data string and a corresponding database field, and associating the selected parsed data string with the selected database field. The save block 68 preferably saves the selected parsed data strings to the associated database fields.

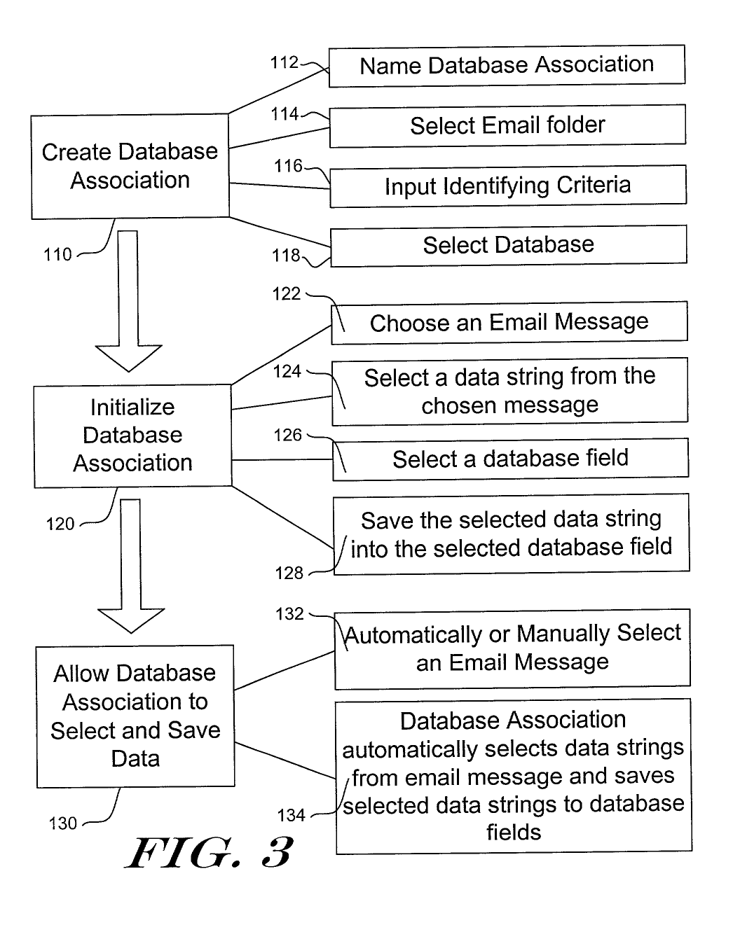

FIG. 3 is a block diagram showing an illustrative process in accordance with the present invention. In this illustrative process, a user creates a database association 110, which includes naming the database association 112, selecting an email folder 114, inputting identifying criteria 116, and selecting a database 118. The naming of the database association 112 gives the association an identifier that can later be used to retrieve, recall or otherwise facilitate reuse of a particular database association. The selection of an email folder 114 and a database 118 may take place through text input by a user, or may be performed using browse functions well known in the art, which allow a user to graphically select a file from among those stored in memory that can be accessed by a computer, or through any other file or folder selection mechanism. Inputting selection criteria 116 may include inputting criteria for enabling the database association to identify and select email messages that are of a particular format or formats. Inputting identifying criteria 116 may include entering parsing criteria that the database association may use to identify data strings in an email message.

The database association is then initialized at 120. Initialization 120 may include choosing an email message 122, selecting a data string from the chosen email message 124, selecting a database field 126, and saving the selected data string to the selected database field 128. Choosing an email message may be performed by, for example, using a graphical interface, text input, or other method. Selecting a data string, shown at block 124, may be performed by manually highlighting a string of data within the message. The selection of a data string is preferably performed by a user after the database association identifies a number of parsed data strings using the identifying criteria input at block 116.

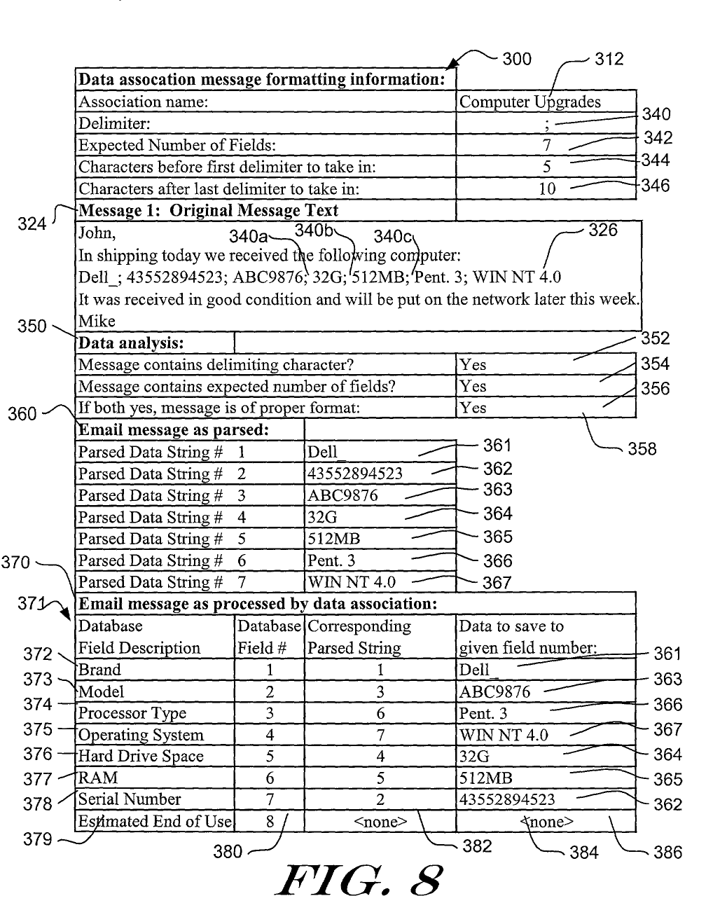

After a data string is selected at block 124, a database field is selected at block 126. Then, the selected data string may be saved to the selected database field at block is 128. The database association may record information relating to the correspondence between the selected data string and the selected database field. For example, a database association may number the parsed data strings from an email message and may also number the fields in a database. As part of initialization of the database, the database association may save information that relates the numbered parsed data strings to the numbered database fields. FIG. 8 and the accompanying description provided a more detailed example of such an initialization step in which the database association saves data indicating which parsed data strings are to be saved to which database fields.

Following the initialization of the database association 120, the program may allow the database association to select and save data, as shown at block 130. This may be performed automatically, or in response to a user prompt. In one embodiment, the database association automatically selects an email message, or a user may select an email message, as shown at block 132. Automatic selection may take place based on the identifying criteria entered at block 116. Manual selection may take place using a graphical interface. Having selected an email message 132, the database association may automatically identify and select data strings from the selected email message and save the selected data strings to corresponding database fields 134 using the information saved during database association initialization at block 120.

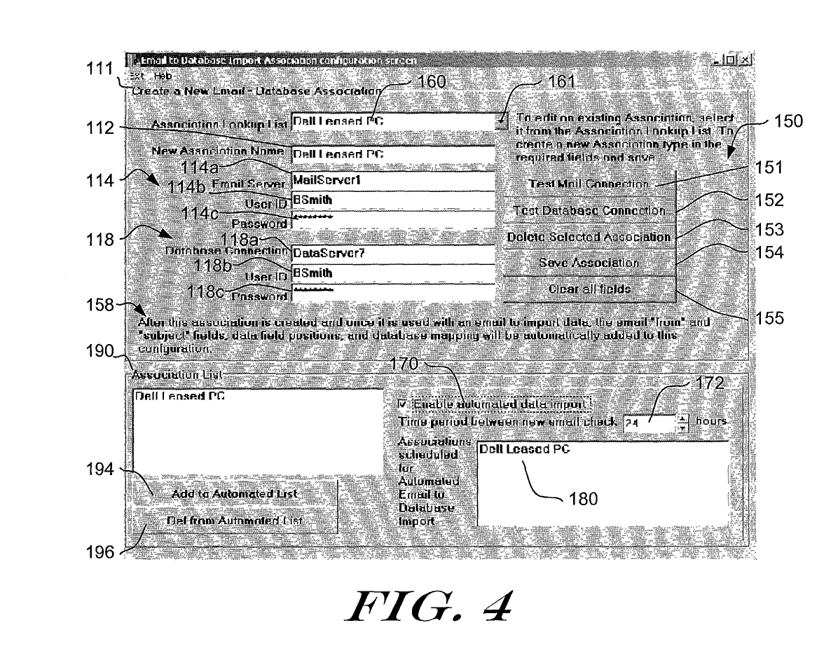

FIG. 4 is a screen shot of an illustrative graphical user interface for designating an association. The illustrative screen shot shows “Create a New Email—Database Association” at 111. The association is given a name at dialog box 112, and designations identifying an email server and a database are given at dialog boxes 114 and 118, respectively. The email server information may include, for example, a server address or name, as shown at 114a, a user identifier, as shown at 114b, and a password, as shown at 114c, though more or less information may be provided depending on the application.

Database information may include a database connection, as shown at 118a, a user identifier, as shown at 118b, and a password, as shown at 118c, although more or less information may be provided depending on the application. It is contemplated that in some embodiments, the email server information and database information need not be provided by the user. Rather, this information may be pre-programmed or hard-coded. In other illustrative embodiments, the association may be programmed to search for and identify databases and email folders that are accessible by the import program.

The illustrative embodiment may include a number of other functions, generally shown at 150. In order to help ensure that information given by the user actually provides the association with access to an email folder, a test mail connection button 151 is included. Likewise, a test database connection button 152 may be provided to help assure that the association has access to the desired database. Associations may be deleted using button 153 or saved using button 154. The association information shown in FIG. 4 may be reset with the clear all fields button 155.

After the association is created and used once with an email message to import data, the email “from” and “subject” fields, data field positions, and database mapping is automatically added to the configuration of the database association, as indicated at 158. The association 160 being configured is shown, and a browse for other associations button 161 may be provided. The browse for other associations button 161 may give access to other associations directly, or may enable the user to browse other accessible memory files, such as those on a floppy diskette, on the computer's hard drive, or a network hard drive.

A check box 170 may enable automated data import by the association, and another input location 172 may include the time period between new email checks. Another space 180 shows the names of associations scheduled for automated email to database import. An association list 190 shows the name of the association being configured, and includes buttons enabling the user to add to the automated list 180 or delete from the automated list, as shown at 194 and 196, respectively.

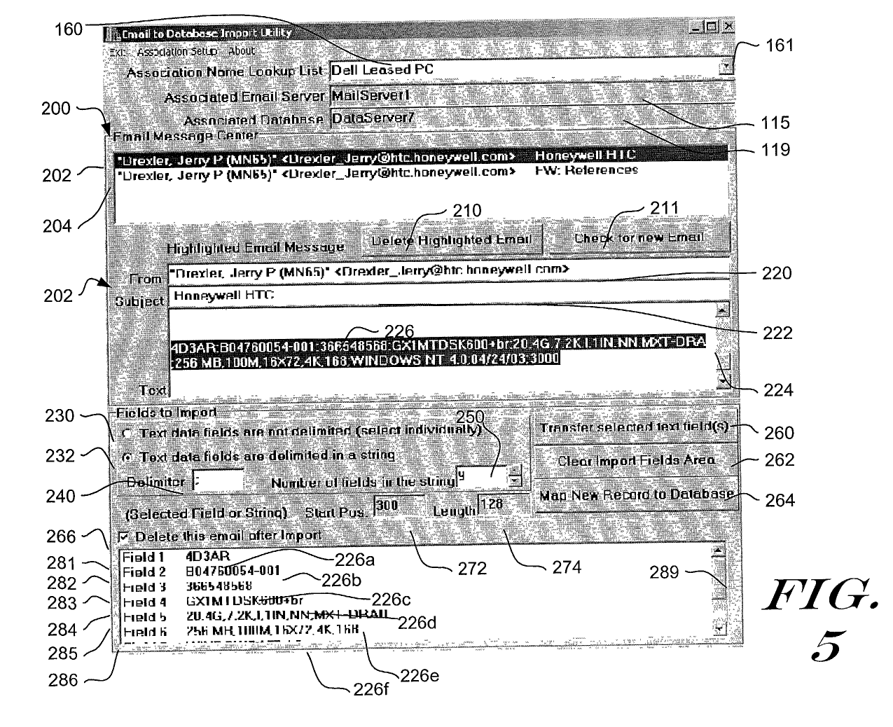

FIG. 5 is a screen shot of an illustrative graphical user interface for manually associating data of an email message with fields of a database. The associated email server 115 and associated database 119 are shown, as is the name of the association being configured at 160. A drop down button 161 enables other associations to be browsed and selected, if desired. In this graphical representation, the illustrative example is showing the parsing of a particular email message that is highlighted and selected by the user.

The email server contents are shown in the email message center 200. In the illustrative embodiment, two messages 202, 204 are displayed, of which message 202 is selected. The illustrative embodiment enables a user to delete a highlighted email message by clicking on button 210, and to check for new email messages by clicking on button 211. The selected email message 202 includes a line showing information regarding the sender 220 of the email and the subject 222 of the email, as well as the message contents 224. A part of the text is highlighted, as shown at 226. The user is given a choice between text data fields not delimited, or text data fields delimited, as indicated by buttons 230 and 232, respectively. In the illustrative example, the user has chosen text data fields delimited button 232.

The delimiter character is shown in dialog box 240, and the user is able to choose the number of fields to process via dialog box 250. Alternatively, the number of fields may be calculated or provided in the association, rather than chosen by the user, if desired. Buttons for transferring selected text fields, clearing import field areas and mapping new record to the database are also provided, as shown at 260, 262, 264, respectively. The user may choose to have the utility program create a new record in the database to which data from the email message 202 may be saved, preferably by selecting the map new record to database button 264.

Other functions are also provided in the illustrative embodiment. For example, the user may choose to delete an email after import 266. The user may also select a start position 272 in the email message from which data to be saved is to begin, and a length of the email message to process, as shown at 274. The user may enter these values 272, 274, or the utility may generate the values after the user creates (graphically or textually) a block of highlighted data, as shown at 226.

In the illustrative embodiment, the highlighted text 226 includes a number of occurrences of the delimiter character specified in dialog box 240. The utility may use the locations of the delimiter character in the email message to divide the email message into a number of import field designations 281-286, each containing a data string 226(a-f) from the highlighted block of message text 226. The list of data strings 226(a-f) and their import field designations 281-286 can be scrolled through using a scroll button 289 or other known scrolling techniques.

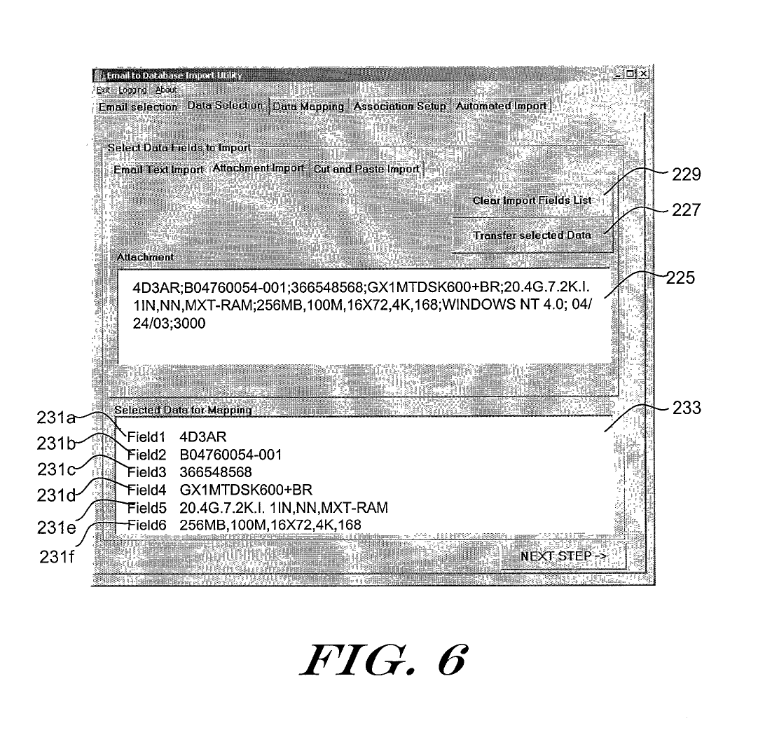

As indicated above, it may be desirable to associate data within an email attachment to selected fields within a database. This may be accomplished in the same ways as described herein with respect to email message text. FIG. 6 is a screen shot of an illustrative graphical user interface for associating data from an email attachment with selected fields of a database. In this illustrative embodiment, the attachment is displayed in attachment window 225, and the designated delimiter character is “;”. Buttons for transferring selected text fields and clearing import field areas are also provided, as shown at 227 and 229, respectively.

It is contemplated that the attachments may be of a number of formats. For example, the attachments may be in Microsoft Excel®, Microsoft Word®, Adobe Acrobat®, or some other format. The utility preferably invokes the appropriate application program to display the attachment in the attachment window 225. Once displayed, the user may manually select the appropriate data strings and assign them to corresponding database fields. The locations of the data strings may be noted, and one or more API programs may be subsequently used for automatically selecting and/or copying data from subsequent email attachments. A cut/paste feature may also be provided for manually import the data into the appropriate data field.

The data in the illustrative attachment window 225 includes a number of occurrences of the designated delimiter character. In the illustrative embodiment, the utility uses the locations of the delimiter characters to divide the data in the email attachment, or selected parts thereof, into a number of data strings. The list of data strings 231(a-f) and their associated import field designations are shown in mapping window 233.

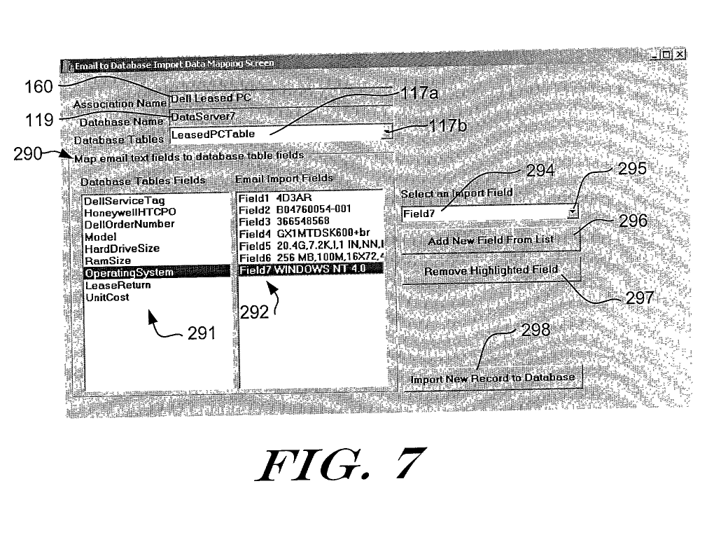

FIG. 7 is a screen shot of an illustrative graphical user interface for mapping parsed data strings from an email message or attachment to database table fields. The association name is shown at 160 and the database name is shown at 119. Also, a database table 117a is shown, as is a button 117b that enables browsing of other possible database tables. In FIG. 7, the user is allowed to map email text fields to database table fields, generally shown at 290. Email text fields can be selected via import field dialog box 294. Additional fields may be added to box 292 by selecting button 296. Highlighted fields in box 292 may be removed using button 297. Again, a new record may be generated in the database by clicking on button 298.

In the illustrative example of FIG. 7, the fields are horizontally aligned to shown the correspondence between the email import fields 292 and the database table fields 291. The email import fields 292 are mapped to corresponding database table fields 291, so that, for example, the Operating System database table field has mapped to it “Field 7” of the email import fields 292, which contains the data string “WINDOWS NT 4.0”, a known operating system trademarked, owned, and marketed by the Microsoft Corporation. The other email import fields in box 292 are likewise mapped to the corresponding database table fields shown in box 291. In the illustrative embodiment, some of the database table fields do not correspond to any email import fields 291. For example, “LeaseReturn” and “UnitCost” have no corresponding to any of the email import fields in the illustrative embodiment.

FIG. 8 is a table showing the operation of an illustrative embodiment of the present invention. The table begins with data association message formatting information 300. The data association message formatting information includes an association name 312, a delimiter character 340, an expected number of fields 342, a number of characters before the first delimiter to take in 344, and a number of characters after the last delimiter character to take in 346.

Message text from an email that has been received is shown at 324. The text includes a data string 326 including several appearances of the delimiter character, as shown, for example, at 340(a-c). Data analysis is shown at 350, noting first if the message contains the designated delimiting character 352, next if the message contains the expected number of fields 354, and finally, if both answers to the previous queries 352, 354 are yes, whether the message is of the proper format 356.

In the illustrative embodiment, the expected number of fields 342 is specified or defined by a user, and determination of whether the proper number of fields are included 354 can be computed by adding one to the number of appearances of the delimiter character 340. The delimiter character appears six times in the text shown at 324, meaning in the case, there are seven fields. One field precedes the first appearance of the delimiter character, another field follows the last appearance of the delimiter character, and all other fields appear between successive appearances of the delimiter character. In the illustrative embodiment, the response is that the message is of the proper format as shown at 358.

The email message as parsed is shown at 360, including a number of parsed data strings 361-367. The email message as parsed is then mapped by the data association, which appears on the table under the “Email message as processed by data association” heading 370. The processed message chart includes a number of database fields 371 with a set of database field descriptions 372-379. Each database field has a number shown in column 380. A mapping, shown in column 382, maps the corresponding parsed data string number to a corresponding database field number. Finally, the data to be saved to the respective database fields is shown in column 384.

The first and last fields are further defined in the illustrative example as including only a certain number of characters. As shown, the first parsed data string 361 includes only “Dell_”, rather than all the text preceding the first delimiter character. Only five character are taken, as directed at 344. Likewise the last parsed data string 367 includes only ten characters “WIN NT 4.0” rather than all of the text following the last delimiter character in the message, as directed at 346. Inclusion of these features may, for example, enable the sender to include a message as well as a formatted data string in an email, though several other features and combinations of features may offer similar capabilities.

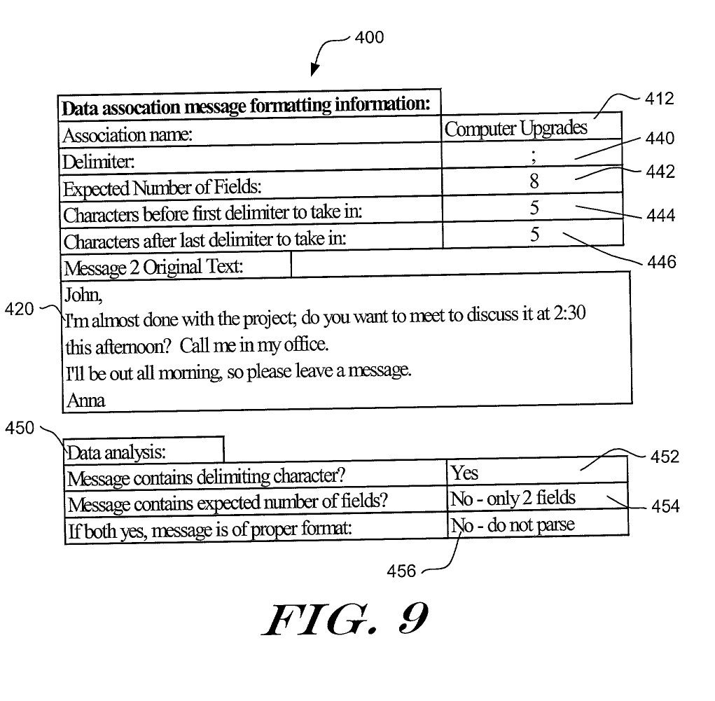

FIG. 9 is a table showing the operation of another illustrative embodiment of the present invention. The table is generally shown at 400. A data association is shown that includes an association name 412, a delimiter character 440, an expected number of fields 442, a number of characters before the first delimiter to take in 444, and a number of characters after the last delimiter to take in 446. The message text is shown at 420, and data analysis is shown at 450. Data analysis 450 may include the same three queries discussed above with respect to FIG. 8. These may include whether the message contains the delimiting character 452, whether the message contains the expected number of fields 454, and whether both responses are yes 456. In the illustrative embodiment, the message text 420 does contain the delimiting character 440, so the first response is yes 452. However, the delimiting character does not appear enough times to cause the message to contain the expected number of fields 442, so the second response 454 is no. Because the second response 454 is no, the third response 456 is also no, yielding a return result. Some illustrative functions that may be part of the return are discussed above with respect to FIG. 2.

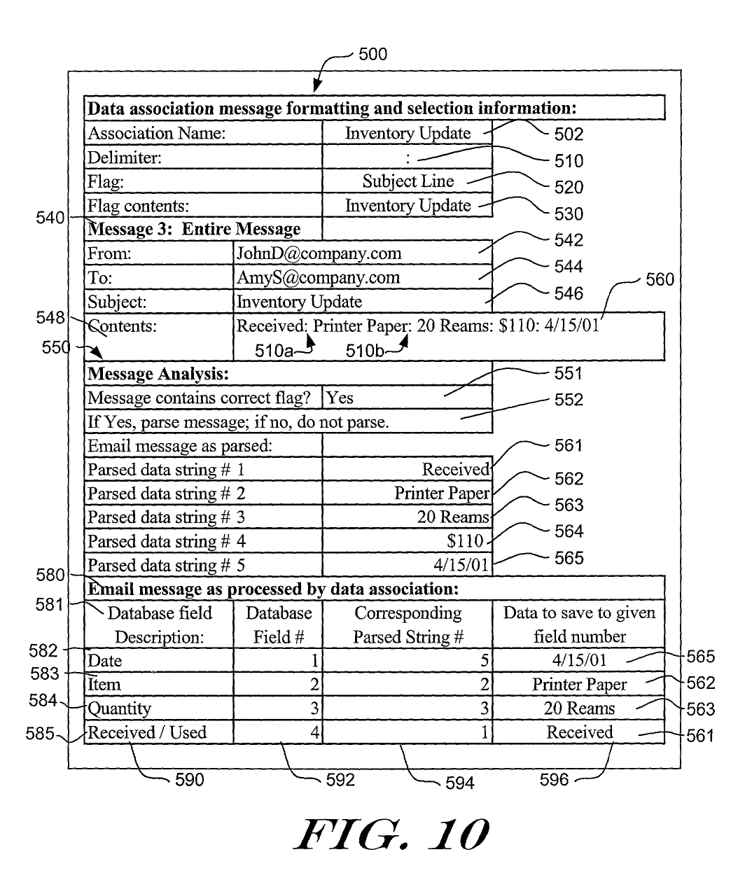

FIG. 10 is a table showing the operation of yet another illustrative embodiment of the present invention. The table is generally shown at 500. An association is shown that includes an association name 502, a delimiter character 510, a flag 520, and flag contents 530. The contents of an email message is shown at 540. The email message contents include a designation of the sender 542, a designation of the recipient 544, a subject line 546 and contents 548 including text 560.

In the illustrative embodiment shown in FIG. 10, rather than relying on the contents 548 of the email message 540 to determine whether the message 540 is of a desired format, the database association uses the flag 520. In this case, the flag corresponds to the subject line 546 of the received email message 540, as shown at 520. The illustrative association compares the contents of the flag 520 to the expected flag contents 530 to determine whether the message 540 is of the desired format. In the illustrative embodiment, the message contains the correct flag, as shown at 551.

Having determined that the message is of the desired format, the association checks for the appearance of the delimiter character 510 in the contents of the message 560. The delimiter 510 appears several times, as shown, for example, at 510a and 510b. The message is parsed into five data strings 561-565, since the delimiter character 510 appears four times in the text 560. The email message is then processed by the data association, as shown at 580. The database field description 581 appears first, as shown at 590, followed by a database field number, as shown at 592. The associated parsed string number is shown next at 594, followed by the corresponding data string at 596. In the illustrative embodiment, one parsed data string 564 is not saved.

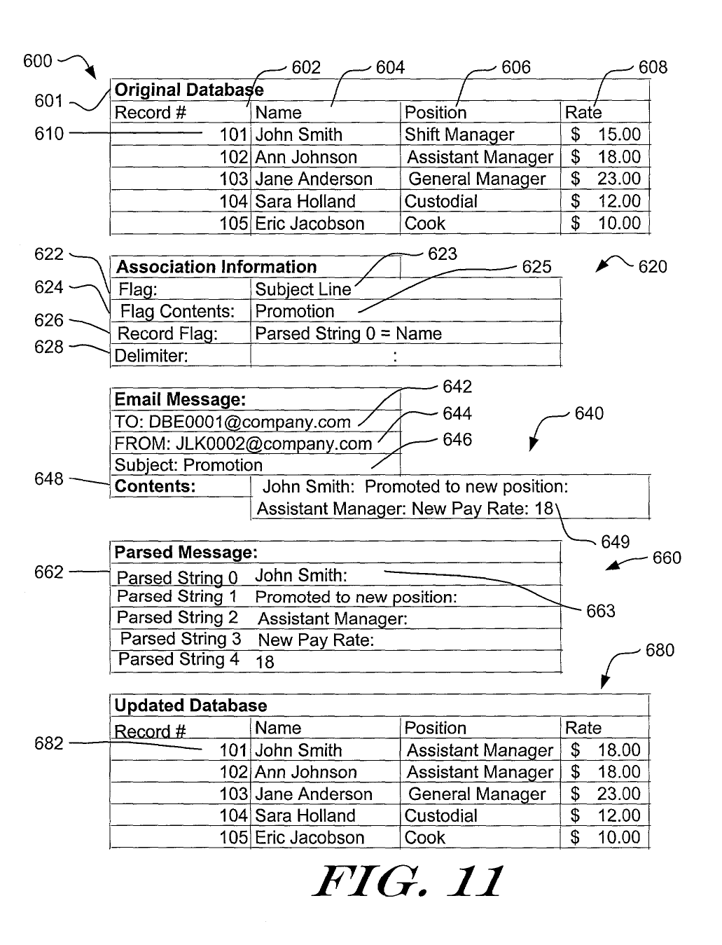

FIG. 11 is a table showing the operation of yet another illustrative embodiment of the present invention. The table is generally shown at 600. The table 600 includes an “Original Database” 601 containing several records each having a number 602, a name 604, a position 606, and a rate 608. One record 610 has number one hundred and one, for an employee with name John Smith, whose position is Shift Manager and who has a pay rate of fifteen dollars an hour. The association 620 contains a flag 622, flag contents 624, a separate flag for a record 626, and a delimiter character 628.

In the illustrative embodiment, an email message 640 is received. The message has recipient information 642, sender information 644, subject information 646 and contents 648 including text 649. Like above, the flag 622 corresponds to the subject line 646 of the email message. Since the flag 622 (subject line) includes the desired flag contents 624 (the term “Promotion”), the email message 640 is parsed. It is contemplated that a flag could be font or case-specific, or may ignore differences in font-face and letter case, for example. Parsing may occur, for example, using parsing steps similar to those described above.

After parsing is complete, the illustrative association searches the database to determine which record, table and/or field that the email message contents should be saved. In the illustrative embodiment, the record flag 626 analyzes the first parsed string, parsed string zero 662, for contents 663 that match the name field 604 of the database. Alternatively, the association may search the database records to determine which among several possible exact or near matches are available, and may present a user with the option to select from several possible matches. In the illustrative example shown, record 610 has contents in the name field 604 that is the same as the contents 663 of parsed string zero 662 (the name “John Smith”). Therefore, the illustrative association 620 performs an updating operation, replacing the contents of the position field 606 and rate field 608 of the original record 610 with parsed string numbers two and four, respectively, to generate updated database 680 including the updated record 682.

FIG. 12 is a table showing the operation of another illustrative embodiment of the present invention. An association is provided with an association name 710, a first delimiter 712, a second delimiter 714, an ignore character 716, a flag location 718 and an indication of expected flag contents 720. A first email message 730 is received, which includes information about the sender 732, subject 734, and text 736. Analysis 740 reveals that the flag contents are as expected 742, so parsing 750 takes place. The parsing occurs based on rules determined to be relevant to the email message received 752. Two data strings are ultimately taken, including a sender name 754 and a parsed data string 756.

As noted at 752, a parsed data string is taken beginning at the occurrence of the first delimiter 712 and ending two characters past the second delimiter 714 if both are number, while ignoring the ignore character 716. The parsing instructions allow capture of a price that is typed into text including the separating commas, and yields a parsed data string 756. In the illustrative example, the parsed data string is, in essence, the price in cents, assuring proper formatting for a database application that receives currency amounts to the nearest penny. It is contemplated that other data matching, formatting, or translating techniques may be used to format data received in an email to be saved into an associated database.

A second email 760 is also shown, having a sender 762, a subject line 764 and contents 766. Analysis 770 reveals that the second message also meets the flag requirements 772, so parsing analysis takes place as shown at 780. In the second email 760, the contents do not contain two additional numbers after the second delimiter 714, as the price is given to the nearest dollar. In order to facilitate consistent data reception for various senders, the parsing analysis 782 may include an instruction to add two zeros if the characters following the second delimiter character are not numbers. In this way, a parsed data string 786 of the proper format may be created.

It is also contemplated that an association may include further data compression, decoding, and/or manipulation capabilities. For example, an association may include capabilities for translating data in a format for a Wordperfect™ document into a format that is compatible with a Microsoft Access™ database. Further, an association may include capabilities for decoding encrypted data, expanding acronyms and abbreviations, or substituting predefined acronyms or abbreviations into parsed data strings before saving the parsed data strings into a database.

In another illustrative embodiment, an association may be used in conjunction with a remote application, where the remote application is distributed to remote or otherwise dispersed users who input data. After receiving data from a user, the remote application may encode the data and send an email message to a predetermined address. The association may then include information relating to an email message folder receiving email messages sent to the predetermined address. The association may be able to identify encoded messages sent by the remote application, and may include a decoding algorithm along with parsing functions so that the association can save data entered by the user to a database.

It is also contemplated that the present invention may automatically generate and send one or more email messages using one or more fields within a database. For example, an email message may be generated when a parameter stored in the database reaches some predefined threshold level. That is, the database may be used to trigger the generation of an email message. In one example, when the inventory of a particular part at a manufacturing facility falls below a predetermined threshold level, an email message may be automatically generated and sent to a supplier of the part. The email message may include selected data from fields within the database, such as part number, order quantity, supplier address, shipping address, etc. The email message may be automatically or manually sent to the supplier, as desired. Another email message may be sent to, for example, an employee of the manufacturing facility to document the order.

Once received by the supplier, selected data strings from the email message may be automatically parsed and stored in the supplier's database. Such changes to the supplier's database may initiate the manufacture and/or delivery of the desired part to the manufacturing facility. This is just one example where the automatic generation and receipt of email messages between databases can improve efficiency.

Numerous advantages of the invention covered by this document have been set forth in the foregoing description. It will be understood, however, that this disclosure is, in many respects, only illustrative. Changes may be made in details, particularly in matters of shape, size, and arrangement of parts without exceeding the scope of the invention. The invention's scope is, of course, defined in the language in which the appended claims are expressed.

What is claimed is:

1. A method of recording data to a database that has a number of database locations, the method comprising the steps of:
receiving an electronic mail message, the electronic mail message including a set of data elements;
selecting a first subset of the data elements;
saving the first subset of data elements to a first location of the database;
selecting a second subset of the data elements; and
saving the second subset of data elements to a second location of the database.

2. The method of claim 1, further comprising the step of determining whether the electronic mail message is in a predefined format.

3. The method of claim 2, wherein the step of determining whether an electronic mail message is in a predefined format includes the steps of:
counting the number of times a predetermined delimiter character appears in the electronic mail message; and
comparing the number of times that the predetermined delimiter character appears in the electronic mail message with to an expected number.

4. The method of claim 3, wherein the expected number is related to the number of fields in the database.

5. The method of claim 1, wherein the first selecting step includes the steps of:
parsing the data elements of the electronic mail message into a number of data strings, wherein each parsed data string includes sequentially positioned data elements in the electronic mail message; and
selecting one of the parsed data string as the first subset of the data elements.

6. The method of claim 5, wherein the second selecting step includes the step of selecting another one of the parsed data string as the second subset of the data elements.

7. The method of claim 5, wherein:
a first parsed data string includes those data elements that precede a first appearance of a predetermined delimiter character;
a last parsed data string includes those data elements that follow a last appearance of the predetermined delimiter character; and
all other parsed data strings are data strings that appear between successive predetermined delimiter characters.

8. The method of claim 5, wherein each of the parsed data strings is saved to a selected database location.

9. The method of claim 5, wherein only selected parsed data strings are saved to a corresponding database location.

10. The method of claim 1, further comprises the step of associating an electronic mail message with a database.

11. A method of recording data to a database that has a number of database fields, the method comprising the steps of:
parsing an electronic mail message into a number of parsed data strings;
providing a correspondence between selected parsed data strings and a database field in the database; and
saving each of the selected parsed data strings to the corresponding database field in the database.

12. The method of claim 11, wherein a user initially defines the correspondence between the selected parsed data strings and the database fields.

13. The method of claim 12, further comprising the step of saving the correspondence between the selected parsed data strings and the database fields that were initially defined by the user.

14. The method of claim 11, wherein the parsing step includes the step of defining a delimiter character.

15. The method of claim 11, wherein the parsing step includes the step of identifying a number of locations within the electronic mail message.

16. A method of recording data to a database that has a number of database fields, the method comprising the steps of:
creating an association between a particular electronic mail message format and the database;
receiving an electronic mail message having the particular electronic mail message format; and
saving selected data from the electronic mail message to selected fields of the database.

17. The method of claim 16, further comprising the step of:
parsing the data within the electronic mail message into parsed data strings;
saving selected parsed data strings into selected fields of a database.

18. The method of claim 16, wherein the saving step includes the steps of:
selecting a first/next parsed data string;
identifying a corresponding field within the database, if any;
saving the first/next parsed data string to the corresponding field within the database; and
repeating the selecting, identifying and saving steps for all parsed data strings in the electronic mail message.

19. A software application comprising:
display means for displaying an electronic mail message and a number of database fields;
data selection means for selecting certain data of the electronic mail message; and
data association means for associating the certain data with one of the number of database fields.

20. The software application of claim 19, wherein the data selection means allows a user to graphically select certain data of the electronic mail message.

21. The software application of claim 19, wherein the data selection means automatically selects certain data of the electronic mail message based on data selection criteria provided by a user.

22. The software application of claim 21, wherein the data selection criteria includes a delimiting character.

23. The software application of claim 19, wherein the data association means allows a user to graphically associate certain data of the electronic mail message with selected database fields.

24. The software application of claim 19, wherein the data association means automatically associates certain data of the electronic mail message with selected database fields.

25. A method of recording data to a database that has a number of database fields, the method comprising the steps of:
analyzing an electronic mail message;
determining whether the electronic mail message should be recorded; and
if the electronic mail message should be recorded, selecting data within the electronic mail message and saving the selected data into predetermined fields of a database.

26. The method of claim 25, wherein all steps are performed without human intervention.

27. The method of claim 26, wherein the step of determining whether the electronic mail message should be recorded includes the step of analyzing the subject line of the electronic mail message.

28. The method of claim 26, wherein the step of determining whether the electronic mail message should be recorded includes the step of analyzing the name of the sender of the electronic mail message.

29. The method of claim 26, wherein the step of determining whether the electronic mail message should be recorded includes the step of analyzing the format of the electronic mail message.
